(19) United States
(12) Patent Application Publication
(10) Pub. No.: US 2024/0106222 A1
(43) Pub. Date: Mar. 28, 2024

(54) ARC RISK MANAGEMENT SYSTEM AND METHOD USING ARTIFICIAL INTELLIGENCE NETWORK

(71) Applicant: Korea Institute of Energy Research, Daejeon (KR)

(72) Inventors: Yoon Dong SUNG, Daejeon (KR); Gi Hwan YOON, Daejeon (KR); Kuk-Yeol BAE, Daejeon (KR); Suk In PARK, Daejeon (KR); Mo Se KANG, Daejeon (KR); Hak Geun JEONG, Daejeon (KR); Hye Jin KIM, Sejong-si (KR)

(73) Assignee: Korea Institute of Energy Research, Daejeon (KR)

(21) Appl. No.: 18/367,149

(22) Filed: Sep. 12, 2023

(30) Foreign Application Priority Data
Sep. 22, 2022 (KR) 10-2022-0119826
Jan. 10, 2023 (KR) 10-2023-0003576
May 30, 2023 (KR) 10-2023-0069387

(51) Int. Cl. H02H 1/00; G06N 3/045

(52) U.S. Cl. CPC H02H 1/0092; G06N 3/045; H02H 1/0015

(57) ABSTRACT

An embodiment of the present disclosure provides an arc risk management method comprising: pre-processing measurement values of currents flowing into an electric apparatus; estimating a level of arc energy in the electric apparatus by inputting the measurement values into one artificial intelligence network comprising a first layer including a dilated convolutional neural network and a second layer including a recurrent neural network; and indicating an arc risk to the electric apparatus in a quantitative way according to the level of arc energy.

### CROSS REFERENCE TO RELATED APPLICATION

This application claims priority to Korea Patent Applications Nos. 10-2022-0119826 filed on Sep. 22, 2022, 10-2023-0003576 filed on Jan. 10, 2023 and 10-2023-0069387 filed on May 30, 2023. which are hereby incorporated by reference in its entirety.

### BACKGROUND

### 1. Field of Technology

The present disclosure relates to a technology for detecting arcs and managing arc risks in an electric apparatus.

### 2. Related Technology

Research on new and renewable energy sources for a next-generation, which will replace fossil fuel energy and nuclear energy and help solve the climate change issue, are actively being conducted. Thus far, the relevant research has been focused on areas dealing with the supply of new and renewable energy sources, the improvement in their efficiencies, and application technologies for the connection with the existing systems, etc. Thus, the relevant technologies have reached a maturational stage. In particular, in the area of solar photovoltaic systems among the new and renewable energy sources, the technological level has rapidly improved and the supply to the market has rapidly increased such that solar photovoltaic systems generate 600 GW-peak of energy, which is more than 3% of the energy used throughout the world. The growth of solar photovoltaic systems has surpassed anticipation. Recently, in addition to such technological progress, requirements for technologies of the relevant examination/management increase, and thus, the relevant market is also gradually expanded.

In solar photovoltaic systems, breakdowns occur mainly in electricity conversion devices, such as an inverter, a combiner, etc. In particular, arcs, which frequently occur in junction boxes where different connectors are connected, are on the rise as a major cause of breakdowns in solar photovoltaic systems. Since arcs may continuously damage systems depending on the energy intensity, they may shorten the lives of products and, in a case when arcs cannot be detected rapidly and accurately, it may even lead to industrial accidents or loss of human life due to fire. For this reason, in this circumstance where new and renewable energy sources represented by solar energy generation are actively supplied, errors in arc detections due to inaccurate detections may cause problems such as life shortening of a system, cost increases in maintenance, etc.

Generally, arcs occur mainly due to damage by external factors such as weathering over time, aging, connections of electrical lines. Such arcs cause the occurrence of high temperature plasma between two electrical lines and this results in continuous damage to internal structures of systems. Meanwhile, characteristics of arc occurrences depending on the types of circuits are as follows: In a case of a parallel circuit, when an arc occurs, a high level of a current is generated. Accordingly, arcs may be relatively easily detected and blocked by using physical protective relay systems such as a fuse, a breaker, etc. In a case of a series AC circuit, an arc may be relatively easily detected because an arc characteristic may be found in a zero crossing point.

On the contrary, arcs that occur in a series DC circuit have no zero point of a current and have a characteristic similar to a pattern of a normal current. In particular, in a case of an inverter in common use having a lot of noise, a current has a relatively big ripple and an abnormal range of a current due to an arc is within a normal range. For this reason, it is very difficult to detect an arc.

In addition, since it is difficult to measure arc energy even when an arc is detected, it is difficult to assess how much of a risk this arc causes to an electrical apparatus.

The discussions in this section are only to provide background information and do not constitute an admission of prior art.

### SUMMARY

In this background, an aspect of the present disclosure is to provide a technology for detecting an arc. Another aspect of the present disclosure is to provide a technology for measuring a level of arc energy in an electric apparatus. Still another aspect of the present disclosure is to provide a technology for managing risk to an electric apparatus caused by an arc. Still another aspect of the present disclosure is to provide a technology for detecting a pre-arc that occurs prior to an arc state.

To this end, in an aspect, the present disclosure provides an arc risk management method comprising: pre-processing measurement values of currents flowing into an electric apparatus; estimating a level of arc energy in the electric apparatus by inputting the measurement values into one artificial intelligence network comprising a first layer including a dilated convolutional neural network and a second layer including a recurrent neural network; and indicating an arc risk to the electric apparatus in a quantitative way according to the level of arc energy.

According to the arc risk management method, in indicating an arc risk in a quantitative way, the arc risk may be indicated in a form of a dial gauge in real time.

The first layer may be a layer transferred from another artificial intelligence network that has conducted learning for classification of first factor values to influence the arc energy.

The recurrent neural network may comprise a transformer layer.

The recurrent neural network may comprise a long short-term memory (LSTM), which is advantageous for time series data analysis.

The one artificial intelligence network may have a structure of a residual neural network (ResNet).

The other artificial intelligence network may distinguish a normal state and an arc state of the electric apparatus by the classification.

In another aspect, the present disclosure provides an arc risk management system comprising: a pre-processing module to pre-process measurement values of currents flowing into an electric apparatus; an artificial intelligence network module, comprising a first layer including a dilated convolutional neural network and a second layer including a recurrent neural network, to receive the measurement values as an input and to output a level of arc energy of the electric apparatus; and an arc risk management module to indicate an arc risk of the electric apparatus in a quantitative way according to the level of arc energy.

The pre-processing module may normalize the measurement values without causing dispersion information to vanish from the measurement values.

The pre-processing module may normalize the measurement values by a mean subtraction normalization (MSN) method.

The first layer may be a layer transferred from another artificial intelligence network that has conducted learning for classification of first factor values to influence the arc energy.

The recurrent neural network may comprise a long short-term memory (LSTM), which is advantageous for time series data analysis.

One artificial intelligence network may have a structure of a residual neural network (ResNet).

The other artificial intelligence network may classify the measurement values into two or more current levels.

The arc risk management module may further comprise a display module to indicate quantitative indexes of the arc risk in a form of a gauge.

The first factor values are current levels and the other artificial intelligence network may be an artificial intelligence network which has learned to classify levels of currents flowing into the electric apparatus in a state where an arc has occurred.

As described above, according to the present disclosure, an arc may be detected more accurately. According to the present disclosure, a level of arc energy in an electric apparatus may be measured more accurately. According to the present disclosure, risk to an electric apparatus due to an arc may be managed. In addition, according to the present disclosure, a pre-arc that occurs prior to an arc state may be detected to minimize damage to a system due to an arc and make a system to be in a safe state earlier.

### BRIEF DESCRIPTION OF THE DRAWINGS

In order that the disclosure may be well understood, there will now be described various forms thereof, given by way of example, reference being made to the accompanying drawings, in which:

FIG. 1 is a configuration diagram of an electric power system according to embodiments of the present disclosure;

FIG. 2 is a configuration diagram of a device according to a first embodiment;

FIG. 3 is a graph showing arc voltages depending on current levels when arcs occur in a direct current wire;

FIG. 4 is a graph showing arc energies depending on current levels when arcs occur in a direct current wire;

FIG. 5 is an illustrative diagram of a dial gauge to indicate arc risks in a quantitative way;

FIG. 6 is a configuration diagram of a first example of an artificial intelligence network included in an artificial intelligence network module according to a first embodiment;

FIG. 7 is a configuration diagram of a learning device according to a first example of a first embodiment;

FIG. 8 is a configuration diagram of an experiment set to verify performance of a device according to embodiments of the present disclosure;

FIG. 9 is a configuration diagram of a second example of an artificial intelligence network included in an artificial intelligence network module according to a first embodiment;

FIG. 10 is a configuration diagram of a learning device according to a second example of a first embodiment;

FIG. 11 is a configuration diagram of a third example of an artificial intelligence network included in an artificial intelligence network module according to a first embodiment;

FIG. 12 is a configuration diagram of a learning device according to a third example of a first embodiment;

FIG. 13 is a configuration diagram of a fourth example of an artificial intelligence network included in an artificial intelligence network module according to a first embodiment;

FIG. 14 is a configuration diagram of a learning device according to a fourth example of a first embodiment;

FIG. 15 is a flow diagram of an arc risk management method according to a first embodiment;

FIG. 16 is a diagram showing waveforms of a current and a voltage in an arc gap;

FIG. 17 is a diagram showing arc energies in a pre-arc state and in an arc state;

FIG. 18 is a configuration diagram of a device according to a second embodiment;

FIG. 19 is a configuration diagram of an artificial intelligence network according to a second embodiment;

FIG. 20 is a configuration diagram of a learning device according to a second embodiment;

FIG. 21 is an illustrative diagram of a result of a heat map produced by the Grad-CAM;

FIG. 22 is a flow diagram of a method for detecting pre-arcs according to a second embodiment; and

FIG. 23 is a diagram showing an experiment result of an arc risk management system according to a second embodiment.

### DETAILED DESCRIPTION OF EMBODIMENTS

Hereinafter, some embodiments of the present disclosure will be described in detail with reference to the accompanying drawings. With regard to the reference numerals of the components of the respective drawings, it should be noted that the same reference numerals are assigned to the same components even though they are shown in different drawings. In addition, in describing the present disclosure, a detailed description of a well-known configuration or function related the present disclosure, which may obscure the subject matter of the present disclosure, will be omitted.

In addition, terms, such as “1st”, “2nd”, “A”, “B”, “(a)”, “(b)”, or the like, may be used in describing the components of the present disclosure. These terms are intended only for distinguishing a corresponding component from other components, and the nature, order, or sequence of the corresponding component is not limited to the terms. In the case where a component is described as being “coupled”, “combined”, or “connected” to another component, it should be understood that the corresponding component may be directly coupled or connected to another component or that the corresponding component may also be “coupled”, “combined”, or “connected” to the component via another component provided therebetween.

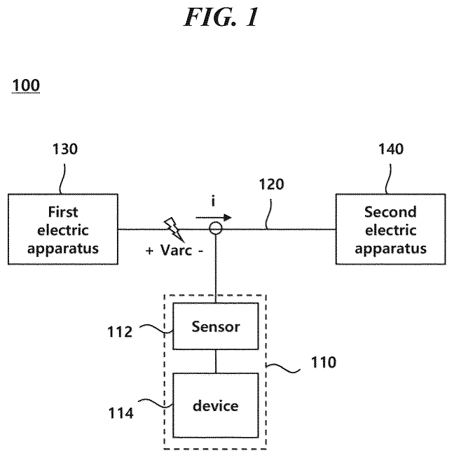

FIG. 1 is a configuration diagram of an electric power system according to embodiments of the present disclosure.

Referring to FIG. 1, an electric power system 100 may comprise a first electric apparatus 130 and a second electric apparatus 140. The first electric apparatus 130 and the second electric apparatus 140 may be electrically connected through a wire 120. The first electric apparatus 130 may supply a current i to the wire 120 and the second electric apparatus 140 may be supplied with a current i from the wire 120.

The first electric apparatus 130 may comprise an electric power converting device. For example, the first electric apparatus 130 may comprise a solar photovoltaic device as a power generation device and an electric power converting device to convert electric power generated by the solar photovoltaic device and to supply the electric power to the wire 120. For another example, the first electric apparatus 130 may comprise an energy storage device and an electric power converting device to covert electric power stored in the energy storage device and to supply the electric power to the wire 120.

The electric power converting device comprised in the first electric apparatus 130 may comprise a power semiconductor and convert electric power in a way of chopping electric power using the power semiconductor. For example, the electric power converting device may be a buck converter, a boost converter, a flyback converter, etc.

The electric power converting device comprised in the first electric apparatus 130 may have a predetermined control frequency or a control frequency within a predetermined range. Here, the control frequency may determine a period for an electric power chopping. Such periodical chopping of electric power may cause noise in the first electric apparatus 130 and the wire 120.

The second electric apparatus 140 may comprise an electric power converting device. The electric power converting device may be comprised either in the first electric apparatus 130 or in the second electric apparatus 140. The electric power converting device may also be comprised in both the first electric apparatus 130 and the second electric apparatus 140.

The first electric apparatus 130 may comprise a device for supplying electric power (for example, a solar photovoltaic device, an energy storage device, etc.) and the second electric apparatus 140 may comprise an electric power converting device to convert electric power supplied from the first electric apparatus 130.

The electric power converting device comprised in the second electric apparatus 140 may comprise a power semiconductor and convert electric power in a way of chopping electric power using the power semiconductor. For example, the electric power converting device may be a buck converter, a boost converter, a flyback converter, etc.

The electric power converting device comprised in the second electric apparatus 140 may have a predetermined control frequency or a control frequency within a predetermined range. Here, the control frequency may determine a period for an electric power chopping. Such periodical chopping of electric power may cause noise in the second electric apparatus 140 and the wire 120.

For known or unknown reasons, an arc may occur in the wire 120. A system 110 for managing risks of breakdowns due to arcs of an electric apparatus (‘a management system’, hereinafter) may detect occurrence of an arc.

The management system 110 may comprise a sensor 112 and a device 114.

The sensor 112 may obtain a measurement value of a current i flowing into the wire 120. The sensor 112 may measure a current i flowing into the wire 120 by using a current sensor to generate time series data.

The sensor 112 may periodically measure a current i and store measured values in a memory in chronological sequence as time series data. The sensor 112 may store the measured values of the currents i, as they are, to generate time series data or may filter or scale the measured values to generate time series data.

The device 114 may analyze the time series data and determine if an arc occurs in the wire 120.

The device 114 may classify the state of the wire 120 into a normal state and an arc state by analyzing the time series data regarding the currents i. Otherwise, the device 114 may classify the state of the wire 120 into a normal state, an arc state, and a pre-arc state.

The normal state may indicate a state without any arcs.

The arc state may indicate a state where arc energy consumed by an arc is maintained to be equal to or higher than a predetermined reference value. The arc energy consumed by an arc may be calculated by multiplication of a current i passing through an arc gap, an arc voltage Varc formed in both ends of the arc gap, and a unit time. Supposing that arc energy is calculated in every unit time, when an arc, having arc energy equal to or higher than a predetermined reference value, continuously occurs during multiple unit times, it can be considered that the wire 120 is in the arc state.

When an electric apparatus—for example, the wire 120—is in the arc state, an arc, emitting energy equal to or higher than the predetermined value, continuously occurs. For this reason, it is highly likely that the electric apparatus enters a dangerous state—for example, a fire state.

The device 114 may have a function to detect an arc state and, when the electric apparatus is determined to be in the arc state, to shut off the supply of electric power to the electric apparatus so that the electric apparatus does not enter the dangerous state. Furthermore, the device 114 may have a function to classify the state of the electric apparatus into the normal state, the arc state, and the pre-arc state and to shut off the supply of electric power to the electric apparatus so that the electric apparatus does not enter the arc state or, even when the electric apparatus has entered the arc state, the arc state may be rapidly ended.

In terms of time, the pre-arc state may indicate a state in a period of transition from the normal state to the arc state. Arc energy in the pre-arc state may be lower than the predetermined value. Otherwise, even if the arc energy in the pre-arc state is equal to or higher than the predetermined value, it may not maintain that value for at least a predetermined duration.

In terms that the arc energy is generally small in the pre-arc state, an arc in the pre-arc state may be referred to as a small energy arc or a weak arc. However, the present embodiment is not necessarily interpreted to be limited to such terms.

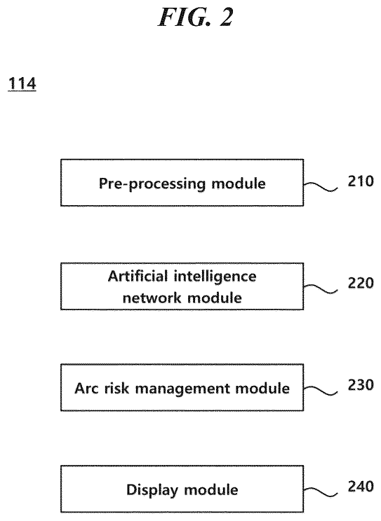

FIG. 2 is a configuration diagram of a device according to a first embodiment.

Referring to FIG. 2, a device 114 may comprise a pre-processing module 210, an artificial intelligence network module 220, an arc risk management module 230, and a display module 240.

The pre-processing module 210 may pre-process measurement values of currents flowing into an electric apparatus.

The pre-processing module 210 may pre-process before inputting the measurement values into an artificial intelligence network.

For an example, the pre-processing module 210 may filter the measurement values with a predetermined frequency band. There may be various noise sources around the sensor. In particular, if the electric power converting device is disposed around the sensor, a high level of noise having a specific frequency band may occur in the electric power converting device. For example, there may be a high level of noise in a switching frequency band of the electric power converting device. The pre-processing module 210 may use a filter to reject such a frequency band in order to minimize the influence of the noise having this frequency band on the measurement values.

For another example, the pre-processing module 210 may control the sensor such that the measurement values can be produced in a predetermined sampling rate or pre-process the measurement values.

The pre-processing module 210 may group the measurement values of currents by a predetermined size of a time section. The measurement values to be inputted into a below described artificial intelligence network may be understood as such measurement values grouped by a predetermined size of a time section.

The pre-processing module 210 may normalize the measurement values. Methods of normalization may be various. However, the pre-processing module 210 according to an embodiment may normalize the measurement values without causing dispersion information to vanish from the measurement values. For example, the pre-processing module may normalize the measurement values by a mean subtraction normalization (MSN) method.

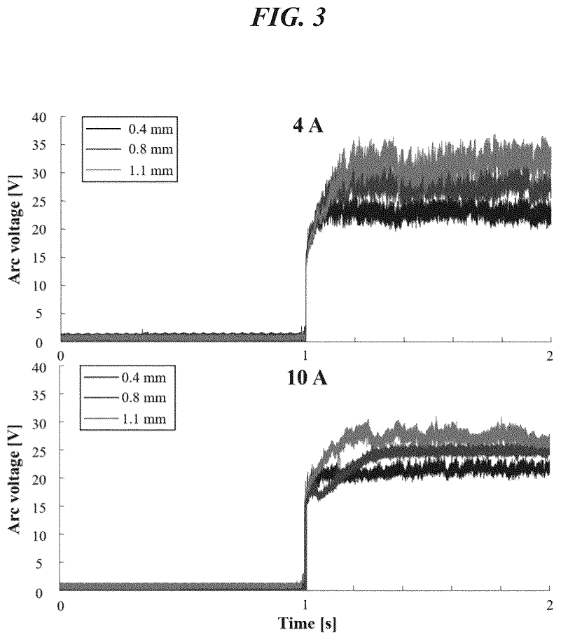

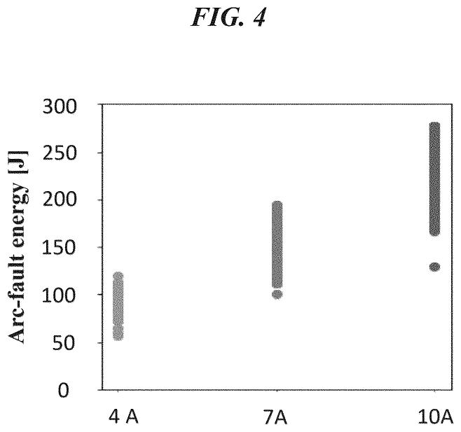

In order to enhance understanding of this technology, the relation between the level of a current of an arc and the level of arc energy in a direct current wire will be described with reference to FIG. 3 and FIG. 4.

FIG. 3 is a graph showing arc voltages depending on current levels when arcs occur in a direct current wire.

Referring to FIG. 3, it can be verified that an arc voltage, when the level of a current flowing into the direct current wire is 4 A, is higher than the level of an arc voltage when the level of a current is 10 A. For example, FIG. 3 shows that, regarding an arc gap of 0.4 mm, the arc voltage is 23V when a current level is 4 A, whereas the arc voltage is 20V when the current level is 10 A. For another example, FIG. 3 shows that, regarding an arc gap of 1.1 mm, the arc voltage is 32V when the current level is 4 A, whereas the arc voltage is 27V when the current level is 10 A.

FIG. 4 is a graph showing arc energies depending on current levels when arcs occur in a direct current wire.

FIG. 4 shows that, although the level of the arc energy increases as the current level increases, an increase value of the arc energy level is not directly proportional to an increase value of the current level, but less than an increase value directly proportional thereto. That is because the level of the arc voltage decreases as the current level increases regarding a predetermined range of current levels.

With this, it can be verified that the current level is a factor value influencing the level of the arc energy.

Referring to FIG. 2 again, the pre-processing module 210 may normalize the measurement values such that the normalization does not cause any factor value elements, influencing the level of an arc energy, to vanish.

For example, the pre-processing module 210 may normalize the measurement values such that the normalization does not cause a current level element to vanish.

As one of such normalization methods, the pre-processing module 210 may use a mean subtraction normalization method. The pre-processing module 210 may normalize the measurement values in a method of calculating a mean value for each time section by which the measurement values are grouped and subtracting a calculated mean value from each measurement value. As such, the mean subtraction normalization method makes a mean value of the measurement values 0, but, distribution characteristics such as a standard deviation, dispersion, or the like would not be changed.

Information about the current level in the measurement values may remain in such distribution characteristics. For example, when the current level is high, a standard deviation value or a dispersion value of the measurement values may be high and, when the current level is low, the standard deviation value or the dispersion value of the measurement values may be low.

Through the normalization by subtracting mean values from the measurement values, the pre-processing module 210 may reduce a calculation load of the artificial intelligence network and improve the input characteristics without causing factor value elements, influencing the arc energy level to be estimated, to vanish, resulting in maintaining accuracy of estimation.

Still referring to FIG. 2, the device 114 may comprise the artificial intelligence network module 220, the arc risk management module 230, and the display module 240.

The artificial intelligence network module 220 may comprise a first layer and a second layer.

Since the measurement values are time series data, the artificial intelligence network module 220 may comprise a long short-term memory (LSTM) layer, which may accurately interpret time series data. However, an LSTM has a disadvantage that learning is not easily performed when there are a lot of features. For this reason, the artificial intelligence network module 220 may comprise a convolutional neural network (CNN), which easily extracts features.

Accordingly, the artificial intelligence network module 220 may comprise an artificial intelligence network using the CNN as the first layer and using the LSTM as the second layer.

The arc risk management module 230 may assess and manage risks of breakdowns of an electric apparatus depending on the arc energy level estimated in the artificial intelligence network module 220.

The arc risk management module 230 may indicate arc risks of an electric apparatus in a quantitative way according to the arc energy level. For example, the arc risk management module 230 may represent arc risks in numerical values.

The arc risk management module 230 may represent quantitative indexes of arc risks in a form of a gauge by using the display module 240. The display module 240 may comprise a display panel and the arc risk management module 230 may represent quantitative indexes of arc risks in a form of a gauge on such a display panel.

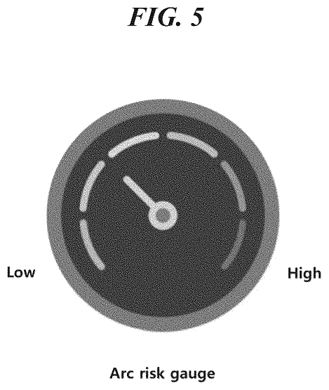

FIG. 5 is an illustrative diagram of a dial gauge to indicate arc risks in a quantitative way.

As shown in FIG. 5, the arc risk management module may represent arc risks in real time in various quantitative ways such as a dial gauge form.

Since the conventional arts previously required various information, such as a current, voltages at both ends, the length of an arc gap, or the like, for estimating energy, they are not practical. However, according to the present disclosure, since only current data is used based on an artificial intelligence, the arc energy may practically be estimated.

In addition, according to the present disclosure, since only current data and a simple pre-processing for normalization are used, a real-time estimation may be assured. Specifically, since an artificial intelligence model used for the present disclosure has a simple hierarchy and is weight-lightened through the TF-Lite, arc energy may be estimated within 50 ms. Such time is shorter than time from an arc occurrence to a breakdown in a system, and thus, it may be considered as a real-time estimation.

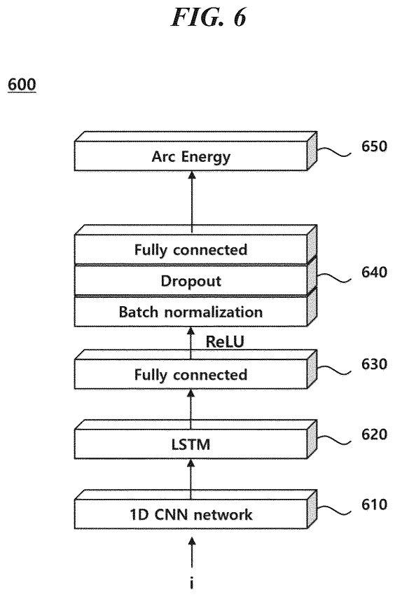

FIG. 6 is a configuration diagram of a first example of an artificial intelligence network included in an artificial intelligence network module according to a first embodiment.

Referring to FIG. 6, an artificial intelligence network 500 may comprise a CNN layer 610, a long short-term memory (LSTM) layer 620, classification layers 630, 640, and a result output layer 650.

The CNN layer 610 may be a one dimension (1D) CNN and current measurement values grouped by a predetermined time section may be inputted into the CNN layer 610.

The LSTM layer 620, which is one type of recurrent neural network (RNN) methods, is a layer developed for preventing the vanishing gradient problem, which is a problem of the conventional RNNs. An output from the CNN layer 610 may be transferred to the LSTM layer 620 and an output from the LSTM layer 620 may be transferred to the classification layers 630, 640.

The classification layers 630, 640 may comprise a fully connected layer 630 including an exponential linear unit (ELU) and another layer 640 including a batch normalization layer, a dropout layer, and a fully connected layer.

A result outputted from the classification layers 630, 640 may be expressed by the result output layer 650 and the above-described artificial intelligence network module may confirm a value of the result output layer 650 and estimate an arc energy level.

The CNN layer 610, which performs a main function in the artificial intelligence network 600, may perform learning using learning data. According to an embodiment, a transfer learning method is used for enhancing the learning efficiency of the CNN layer 610.

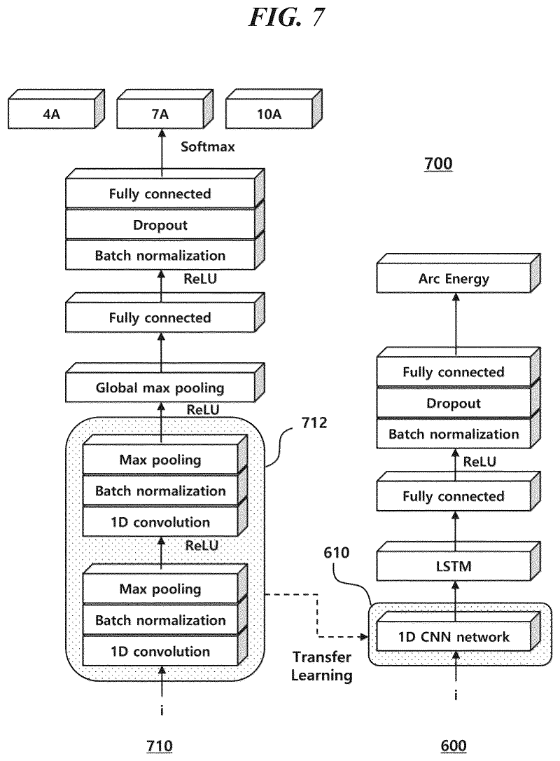

FIG. 7 is a configuration diagram of a learning device according to a first example of a first embodiment.

Referring to FIG. 7, a learning device 700 may comprise two artificial intelligence networks 710, 600.

A first artificial intelligence network 710 may comprise a first CNN layer 712, a global max pooling layer, a fully connected layer, and a classification layer including a batch normalization layer, a dropout layer, and a fully connected layer.

The first artificial intelligence network 710 may perform learning using learning data classified into two or more current levels.

To the first artificial intelligence network 710, measurement values grouped by a predetermined time section may be inputted. Here, current levels regarding the respective measurement values have already been checked. The first artificial intelligence network 710 may perform learning for internal parameters by way of comparing result values for the measurement values with previously checked state values (current level values).

Here, the measurement values inputted into the first artificial intelligence network 710 may be measurement values for a current in an arc state.

A second artificial intelligence network 600 may be the same as the artificial intelligence network described with reference to FIG. 6. The second artificial intelligence network 600 may complete learning in the learning device 700, and then, be inserted into an artificial intelligence network module of an assessment device.

The second artificial intelligence network 600 may perform learning using learning data by which an arc energy level may be estimated.

The second artificial intelligence network 600 may comprise a second CNN layer 610. The second CNN layer 610 may be a transfer learning layer from the first CNN layer 712. Before the second artificial intelligence network 600 performs learning, the first CNN layer 712, which has previously performed learning in the first artificial intelligence network 710, may be inserted in the second CNN layer 610. Then, the second artificial intelligence network 600 may make the second CNN layer 610 to perform learning through re-learning.

Using such transfer learning allows enhancing the accuracy of the second artificial intelligence network 600, to be inserted in the artificial intelligence network module, and lightening the weight thereof.

Here, measurement values inputted into the second artificial intelligence network 600 may be measurement values for a current in a pre-arc state and an arc state.

According to an embodiment, in order to enhance the accuracy and lighten the weight of an artificial intelligence network inserted in the artificial intelligence network module, various elements may be comprised.

A characteristic of an arc may be well revealed in a specific frequency band. When analyzing the frequency of an arc, a higher value can be verified in a specific frequency band. The artificial intelligence network according to an embodiment may confirm a specific frequency band well revealing an arc characteristic and input, into the artificial intelligence network, measurement values filtered by this frequency band or measured at a sampling rate corresponding to this frequency band. In this way, it is possible to lighten the weight of an artificial intelligence network while enhancing the accuracy thereof.

A test is performed in order to verify performance of the first example.

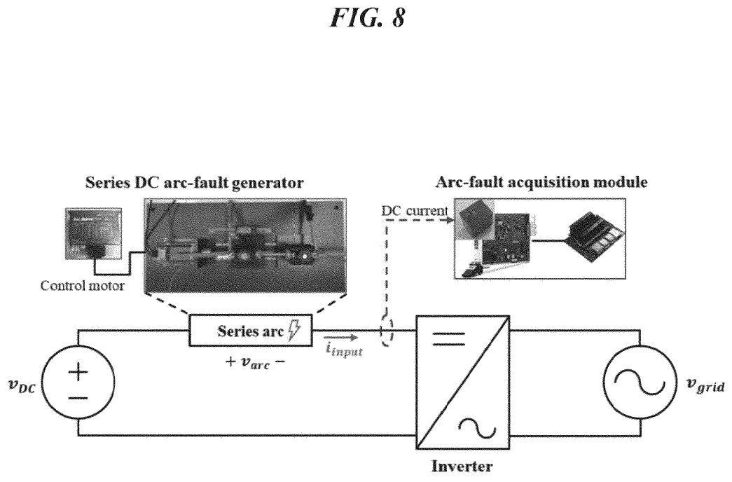

FIG. 8 is a configuration diagram of an experiment set to verify performance of a device according to embodiment of the present disclosure.

Referring to FIG. 8, the experiment set may comprise a direct current source and an inverter connected by a direct current wire. The invertor may be connected with a commercialized electric power network through an alternating current wire.

In the direct current wire between the direct current source and the inverter, a series DC arc fault generator may be disposed. The series DC arc fault generator may form an arc gap in the direct current wire by using a motor. Here, the motor may adjust the size of the arc gap as well as the speed of arc gap formation.

In the direct current wire, a sensor to sense a current may be disposed. A device comprising a calculation processor may obtain current measurement values from the sensor.

A program according to an embodiment may be loaded in the device comprising a calculation processor.

According to a simulation, a means square error (MSE) is calculated to be 8.51 J and a means absolute percentage error (MAPE) is calculated to be 11.03% regarding an artificial intelligence network comprising a 3 layer 1D CNN. Regarding an artificial intelligence network comprising a 2 layer LSTM, the MSE is calculated to be 9.2 J and the MAPE is calculated to be 12.12%.

It shows that the artificial intelligence network, comprising only a CNN or the artificial intelligence network comprising only an LSTM, does not have relatively high performance.

On the contrary, an artificial intelligence network comprising a combination of a 2 layer 1D CNN and an LSTM has 3.06 J of the MSE and 6.37% of the MAPE, which shows an enhanced accuracy in comparison with the above-described artificial intelligence network.

According to a simulation regarding the first example of the first embodiment, when having previously performed learning for the 2 layer 1D CNN in another artificial intelligence network and combining the same with the LSTM through transfer learning to form an artificial intelligence network, this artificial intelligence network (the artificial intelligence network according to the first embodiment) shows 2.22 J of the MSE and 5.20% of the MAPE as a performance test result, which shows the highest accuracy among the artificial intelligence networks tested in their performances.

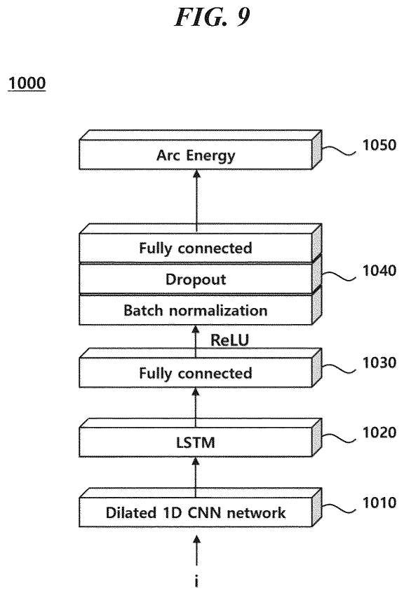

FIG. 9 is a configuration diagram of a second example of an artificial intelligence network included in an artificial intelligence network module according to a first embodiment.

Referring to FIG. 9, an artificial intelligence network 1000 may comprise a dilated CNN layer 1010, a long short-term memory (LSTM) layer 1020, classification layers 1030, 1040, and a result output layer 1050.

The dilated CNN layer 1010, which is a dilated convolutional neural network, may extract characteristics from data by using a dilated convolution. A dilated convolution is to leave an empty space in a kernel so that a filter may function only in a specific pixel. The dilated convolutional neural network may be helpful to maintain the size of data while increasing an effective receptive field of the kernel. In addition, since the dilated convolutional neural network has a larger receptive field regarding input data, it is possible to extract characteristics in a wider range.

The dilated CNN layer 1010 may have several aspects more advantageous than general CNN layers when estimating an arc energy level. For example, the dilated CNN layer 1010 may increase an effective receptive field of a kernel so as to extract characteristics in a wider range. Although it is possible to extract characteristics in a wider range, it does not increase the amount of data in the LSTM layer 1020, which is the next layer. Since the dilated CNN layer 1010 maintains the size of input data as it is, it requires a relatively small memory in comparison with a general CNN using a larger kernel. In addition, since the dilated CNN layer 1010 may process in parallel input data in a larger field, the processing speed may be fast and this leads to the increase of the speed of learning and estimation of a model regarding data in a large scale.

The LSTM layer 1020, which is one type of recurrent neural network (RNN) method, is a layer developed for preventing the vanishing gradient problem, which is a problem of the conventional RNNs. An output from the dilated CNN layer 1010 may be transferred to the LSTM layer 1020 and an output from the LSTM layer 1020 may be transferred to the classification layers 1030, 1040.

The LSTM layer 1020 may manage a previous state in a long term memory state and in a short term memory state. It may operate in a way of processing a current input while maintaining a previous state and reflecting a processed result in a next state. The LSTM layer 1020 may be useful mainly for dealing with long dependence of time series data as described above. Such a characteristic may be suitable for the present disclosure using time series current measurement value data.

The classification layers 1030, 1040 may comprise a fully connected layer 1030 including an exponential linear unit (ELU) and another layer 1040 including a batch normalization layer, a dropout layer, and a fully connected layer.

The exponential linear unit (ELU) is one type of activation functions of artificial neural networks. The ELU function, which is similar to a rectified linear unit (ReLU) function, is designed to converge less rapidly in comparison with a previous function when an input value is equal to or less than 0. A fully connected layer, which is one of basic layers of artificial neural networks, is a layer in which all neurons are connected with all neurons of another layer adjacent to the layer. The fully connected layer may receive input values, calculate output values, and transfer them to the next layer. Using the ELU function in a fully connected layer allows a smooth convergence by using an exponential function when an input value is equal to or less than 0, resulting in alleviating a vanishing gradient problem. The ELU function linearly processes input values of negative numbers and nonlinearly processes input values of positive numbers by using an exponential function. This enables alleviation of a vanishing gradient problem and faster learning. Therefore, the fully connected layer including the ELU may allow forming an artificial neural network model having good performance while resolving the vanishing gradient problem.

A batch normalization is one type of method for normalizing input values in an artificial neural network. This method is to stabilize the distribution of input values by normalizing data of respective mini batches by means and dispersions. When using the batch normalization, the distribution of input values may be stabilized, and thus, the gradient vanishing or exploding problems may be alleviated. In addition, using the batch normalization may also enhance the speed of learning and the performance of generalization. The batch normalization may be useful for a deep learning model such as a convolutional neural network (CNN). A dropout is one type of method for solving an overfitting problem in an artificial neural network. The dropout is a method of randomly selecting some neurons during learning and using the rest of neurons by excluding the selected neurons. This allows preventing the corresponding model from excessively depending on specific neurons and enhancing the generalization performance of the model. According to the dropout, since some neurons are randomly selected in every learning step, the model would learn various cases and this leads to enhancement of the generalization performance. Therefore, the dropout may be useful for a deep learning model such as a convolutional neural network (CNN).

A result outputted from the classification layers 1030, 1040 may be expressed by the result output layer 1050 and the above-described artificial intelligence network module may confirm a value of the result output layer 1050 and estimate an arc energy level.

The dilated CNN layer 1010, which performs a main function in the artificial intelligence network 1000, may perform learning using learning data. According to an embodiment, a transfer learning method is used for enhancing the learning efficiency of the dilated CNN layer 1010.

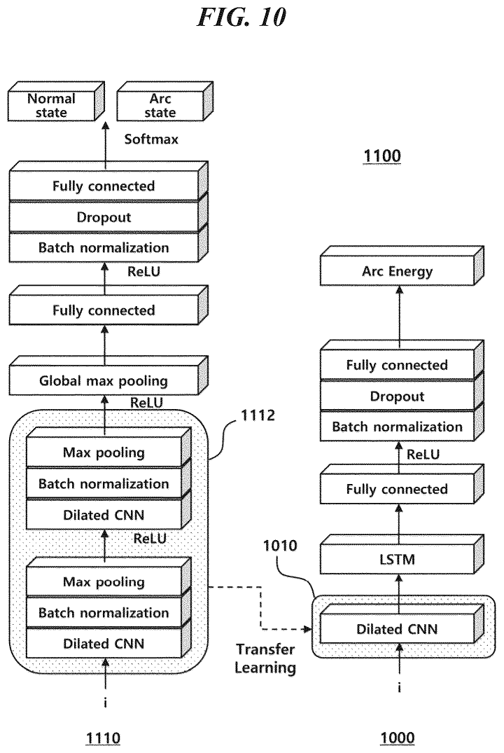

FIG. 10 is a configuration diagram of a learning device according to a second example of a first embodiment.

Referring to FIG. 10, a learning device 1100 may comprise two artificial intelligence networks 1110, 1000.

A first artificial intelligence network 1110 may comprise a first dilated CNN layer 1112, a global max pooling layer, a fully connected layer, and a classification layer including a batch normalization layer, a dropout layer, and a fully connected layer.

The first artificial intelligence network 1110 may perform learning using learning data classifying states of wires into a normal state and an arc state.

To the first artificial intelligence network 1110, measurement values grouped by a predetermined time section may be inputted. Here, current levels regarding the respective measurement values have already been checked. The first artificial intelligence network 1110 may perform learning for internal parameters in a way of comparing result values for the measurement values with previously checked state values (current level values).

Here, the measurement values inputted into the first artificial intelligence network 1110 may be measurement values for a current in an arc state.

A second artificial intelligence network 1000 may be the same as the artificial intelligence network described with reference to FIG. 10. The second artificial intelligence network 1000 may complete learning in the learning device 1100, and then, be inserted into an artificial intelligence network module of an assessment device.

The second artificial intelligence network 1000 may perform learning using learning data by which an arc energy level may be estimated.

The second artificial intelligence network 1000 may comprise a second dilated CNN layer 1010. The second dilated CNN layer 1010 may be a transfer learning layer from the first dilated CNN layer 1112. Before the second artificial intelligence network 1000 performs learning, the first dilated CNN layer 1112, which has previously performed learning in the first artificial intelligence network 1110, may be inserted in the second dilated CNN layer 1010. Then, the second artificial intelligence network 1000 may make the second dilated CNN layer 1010 to perform learning through re-learning.

Using such transfer learning allows enhancing the accuracy of the second artificial intelligence network 1000, to be inserted in the artificial intelligence network module, and lightening the weight thereof.

Here, measurement values inputted into the second artificial intelligence network 1000 may be measurement values for a current in a pre-arc state and/or an arc state.

According to an embodiment, in order to enhance the accuracy and lighten the weight of an artificial intelligence network to be inserted in the artificial intelligence network module, various elements may be comprised.

A characteristic of an arc may be well revealed in a specific frequency band. When analyzing the frequency of an arc, a higher value can be verified in a specific frequency band. The artificial intelligence network according to an embodiment may confirm a specific frequency band well revealing an arc characteristic and input, into the artificial intelligence network, measurement values filtered by this frequency band or measured at a sampling rate corresponding to this frequency band. In this way, it is possible to lighten the weight of an artificial intelligence network while enhancing the accuracy thereof.

According to a simulation, the mean square error (MSE) is calculated to be 3.06 J and the means absolute percentage error (MAPE) is calculated to be 6.37% regarding an artificial intelligence network comprising a combination of a 1D CNN and an LSTM. Regarding an artificial intelligence network to which the transfer learning is not applied and comprising a combination of a dilated CNN and an LSTM, the MSE is calculated to be 2.66 J and the MAPE is calculated to be 5.32%.

This shows that the artificial intelligence network, to which the transfer learning is not applied, does not have relatively high performance.

On the contrary, an artificial intelligence network to which the transfer learning is applied and comprising a combination of a 1D CNN and an LSTM has 2.22 J of the MSE and 5.20% of the MAPE, shows an enhanced accuracy in comparison with the above-described artificial intelligence network.

According to a simulation to which the transfer learning is applied in a second example, an artificial intelligence network, comprising a dilated CNN and an LSTM, shows 1.56 J of the MSE and 4.13% of the MAPE as performance indexes, and this shows the highest accuracy among the artificial intelligence networks tested in their performances.

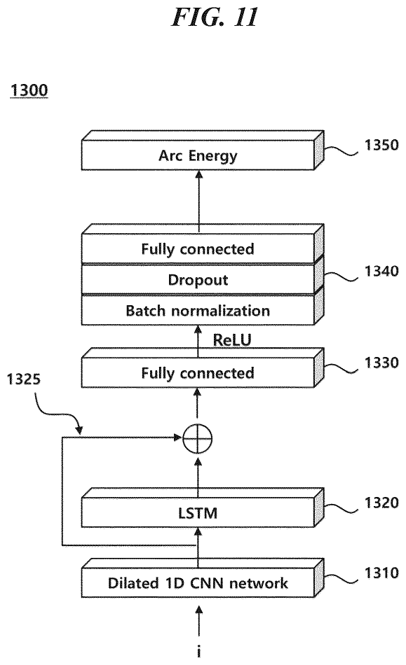

FIG. 11 is a configuration diagram of a third example of an artificial intelligence network included in an artificial intelligence network module according to a first embodiment.

Referring to FIG. 11, an artificial intelligence network 1300 may comprise a dilated CNN layer 1310, a long short-term memory (LSTM) layer 1320, classification layers 1330, 1340, and a result output layer 1350.

The dilated CNN layer 1310, which is a dilated convolutional neural network, may extract characteristics from data by using a dilated convolution. A dilated convolution is to leave an empty space in a kernel so that a filter may function only in a specific pixel. The dilated convolutional neural network may be helpful to maintain the size of data while increasing an effective receptive field of the kernel. In addition, since the dilated convolutional neural network has a larger receptive field regarding input data, it is possible to extract characteristics in a wider range.

The dilated CNN layer 1310 may have several aspects more advantageous than general CNN layers when estimating an arc energy level. For example, the dilated CNN layer 1310 may increase an effective receptive field of a kernel so as to extract characteristics in a wider range. Although it is possible to extract characteristics in a wider range, it does not increase the amount of data in the LSTM layer 1320, which is the next layer. Since the dilated CNN layer 1310 maintains the size of input data as it is, it requires a relatively small memory in comparison with a general DNN using a larger kernel. In addition, since the dilated CNN layer 1310 may process in parallel input data in a larger field, the processing speed may be fast and this leads to the increase of the speed of learning and estimation of a model regarding data in a large scale.

The LSTM layer 1320, which is one type of recurrent neural network (RNN) method, is a layer developed for preventing the vanishing gradient problem, which is a problem of the conventional RNNs. An output from the dilated CNN layer 1310 may be transferred to the LSTM layer 1320 and an output from the LSTM layer 1320 may be transferred to the classification layers 1330, 1340.

The LSTM layer 1320 may manage a previous state in a long term memory state and in a short term memory state. It may operate in a way of processing a current input while maintaining a previous state and reflecting a processed result in a next state. The LSTM layer 1320 may be useful mainly for dealing with long dependence of time series data as described above. Such a characteristic may be suitable for the present disclosure using time series current measurement value data.

The classification layers 1330, 1340 may comprise a fully connected layer 1330 including an exponential linear unit (ELU) and another layer 1340 including a batch normalization layer, a dropout layer, and a fully connected layer.

The exponential linear unit (ELU) is one of activation functions of artificial neural networks. The ELU function, which is similar to a rectified linear unit (ReLU) function, is designed to converge less rapidly in comparison with a previous function when an input value is equal to or less than 0. A fully connected layer, which is one of basic layers of artificial neural networks, is a layer in which all neurons are connected with all neurons of another layer adjacent to the layer. The fully connected layer may receive input values, calculate output values, and transfer them to the next layer. Using the ELU function in a fully connected layer allows a smooth convergence by using an exponential function when an input value is equal to or less than 0, resulting in alleviating a vanishing gradient problem. The ELU function linearly processes input values of negative numbers and nonlinearly processes input values of positive numbers by using an exponential function. This enables alleviation of a vanishing gradient problem and faster learning. Therefore, the fully connected layer including the ELU may allow forming an artificial neural network model having good performance while resolving the vanishing gradient problem.

A batch normalization is one type of method for normalizing input values in an artificial neural network. This method is to stabilize the distribution of input values by normalizing data of respective mini batches by means and dispersions. When using the batch normalization, the distribution of input values may be stabilized, and thus, the gradient vanishing or exploding problems may be alleviated. In addition, using the batch normalization may also enhance the speed of learning and the performance of generalization. The batch normalization may be useful for a deep learning model such as a convolutional neural network (CNN). A dropout is one type of method for solving an overfitting problem in an artificial neural network. The dropout is a method of randomly selecting some neurons during learning and using the rest of neurons by excluding the selected neurons. This allows preventing the corresponding model from excessively depending on specific neurons and enhancing the generalization performance of the model. According to the dropout, since some neurons are randomly selected in every learning step, the model would learn various cases and this leads to enhancement of the generalization performance. Therefore, the dropout may be useful for a deep learning model such as a convolutional neural network (CNN).

A result outputted from the classification layers 1330, 1340 may be expressed by the result output layer 1350 and the above-described artificial intelligence network module may confirm a value of the result output layer 1350 and estimate an arc energy level.

The artificial intelligence network 1300 may have a structure of a residual neural network (ResNet) 1325. The residual neural network 1325 is a deep learning model proposed to alleviate the gradient vanishing problem occurring in a deep learning of an artificial neural network. Unlike traditional deep learning models, the ResNet introduces a new structure called a skip connection. The skip connection does not simply transfer input data to an output layer, but operates in a way of performing an addition in an intermediate layer. In this way, information loss occurring when input data is transferred through a network may be minimized. The ResNet shows good performance even when an artificial intelligence network has a depth comprising tens of or hundreds of layers. That is because the skip connection alleviates the vanishing gradient problem and allows learning of a deeper network.

The dilated CNN layer 1310, which performs a main function in the artificial intelligence network 1300, may perform learning using learning data. According to an embodiment, a transfer learning method is used for enhancing the learning efficiency of the dilated CNN layer 1310.

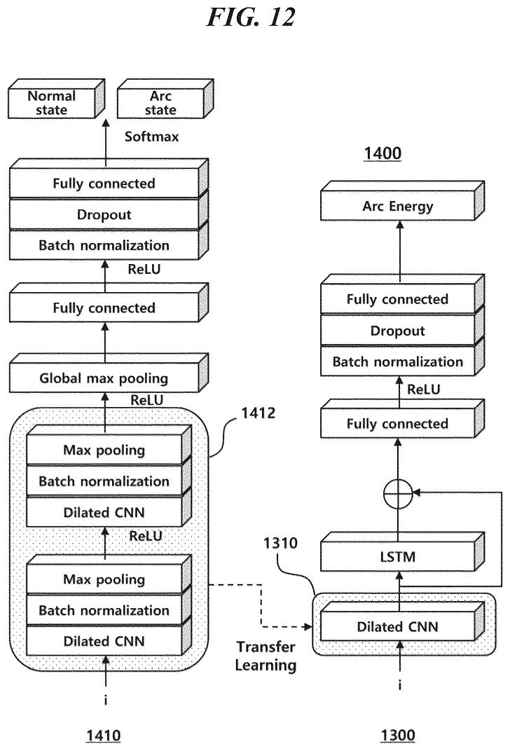

FIG. 12 is a configuration diagram of a learning device according to a third example of a first embodiment.

Referring to FIG. 12, a learning device 1400 may comprise two artificial intelligence networks 1410, 1300.

A first artificial intelligence network 1410 may comprise a first dilated CNN layer 1412, a global max pooling layer, a fully connected layer, and a classification layer including a batch normalization layer, a dropout layer, and a fully connected layer.

The first artificial intelligence network 1410 may perform learning using learning data for classifying states of wires into a normal state and an arc state.

To the first artificial intelligence network 1410, measurement values grouped by a predetermined time section may be inputted. Here, current levels regarding the respective measurement values have already been checked. The first artificial intelligence network 1410 may perform learning for internal parameters in a way of comparing result values for the measurement values with previously checked state values (current level values).

Here, the measurement values inputted into the first artificial intelligence network 1410 may be measurement values for a current in an arc state.

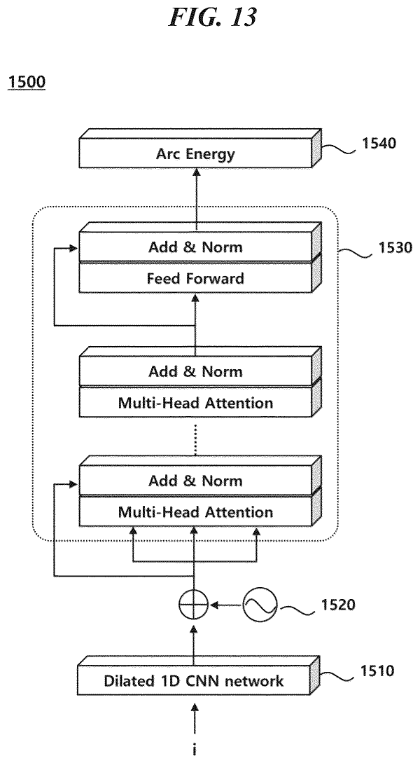

A second artificial intelligence network 1300 may be the same as the artificial intelligence network described with reference to FIG. 13. The second artificial intelligence network 1300 may complete learning in the learning device 1400, and then, be inserted into an artificial intelligence network module of an assessment device.

The second artificial intelligence network 1300 may perform learning using learning data by which an arc energy level may be estimated.

The second artificial intelligence network 1300 may comprise a second dilated CNN layer 1310. The second dilated CNN layer 1310 may be a transfer learning layer from the first dilated CNN layer 1412. Before the second artificial intelligence network 1300 performs learning, the first dilated CNN layer 1412, which has previously performed learning in the first artificial intelligence network 1410, may be inserted in the second dilated CNN layer 1310. Then, the second artificial intelligence network 1300 may make the second dilated CNN layer 1310 to perform learning through re-learning.

Using such transfer learning allows enhancing the accuracy of the second artificial intelligence network 1300, to be inserted in the artificial intelligence network module, and lightening the weight thereof.

Here, measurement values inputted into the second artificial intelligence network 1300 may be measurement values for a current in a pre-arc state and/or an arc state.

FIG. 13 is a configuration diagram of a fourth example of an artificial intelligence network included in an artificial intelligence network module according to a first embodiment.

Referring to FIG. 13, an artificial intelligence network 1500 may comprise a dilated CNN layer 1510, a positional encoder 1520, and a transformer layer 1530.

The dilated CNN layer 1510, which is a dilated convolutional neural network, may extract characteristics from data by using a dilated convolution. A dilated convolution is to leave an empty space in a kernel so that a filter may function only in a specific pixel. The dilated convolutional neural network may be helpful to maintain the size of data while increasing an effective receptive field of the kernel. In addition, since the dilated convolutional neural network has a larger receptive field regarding input data, it is possible to extract characteristics in a wider range.

The dilated CNN layer 1510 may have several aspects more advantageous than general CNN layers when estimating an arc energy level. For example, the dilated CNN layer 1510 may increase an effective receptive field of a kernel so as to extract characteristics in a wider range. Although it is possible to extract characteristics in a wider range, it does not increase the amount of data in the transformer layer 1530, which is the next layer. Since the dilated CNN layer 1510 maintains the size of input data as it is, it requires a relatively small memory in comparison with a general DNN using a larger kernel. In addition, since the dilated CNN layer 1510 may process in parallel input data in a larger field, the processing speed may be fast and this leads to the increase of the speed of learning and estimation of a model regarding data in a large scale.

The positional encoder 1520 may be used in a sequence model such as the transformer layer 1530. It may help that the model learns the sequence of input signals by adding position information of an input signal to an embedding layer.

A transformer model may represent input signals of an input sequence in vectors through the embedding. However, an embedding layer of a basic transformer model may not include position information of input signals even though the embedding layer may represent meanings of input signals. In the input sequence, an order of input signals may have major influence on the meanings. For reflecting this, the positional encoder 1520 may be used.

The positional encoder 1520 may operate in a way of adding vectors having position information to the embedding layer. In general, position information may be given by using a sine function and a cosine function. Each position information vector has a unique value depending on the position of an input signal and the distance and the relative position of the input signal may be encoded.

The transformer layer 1530 may comprise an encoder and a decoder and respective modules may comprise multiple multi-head attention layers and a feedforward neural network layer.

In a multi-head attention layer, a self-attention mechanism is divided into multiple “heads” and the heads are performed in parallel. The respective heads may comprise different weighted matrixes and learn various expressions regarding input sequences.

Using the multi-head attention layer, input sequences may be seen from various perspectives by using independences of the respective heads. In this way, the transformer model may well understand the context of input signals and model interactions between the input signals. The multi-head attention layer may be used mainly in self-attention layers in the encoder and the decoder.

In the transformer layer 1530, the feed-forward neural network layer may be applied after the multi-head attention layer or it may be a fully connected neural network, which may be independently applied in each applied position.

The feed-forward neural network layer may comprise receiving an input vector, having the input vector go through a linear transformation, and applying a non-linear activation function to the input vector. Generally, an ReLU activation function may be used. Then, the input vector may go through a second linear transformation and a final output value may be obtained.

In the transformer model, the feed-forward neural network layer may be applied to a result from each multi-head attention layer and learn each individual characteristic of every position. In this way, the model may learn various expressions in respective positions and perceive complicated patterns.

A result outputted from the transformer layer 1530 may be expressed by a result output layer 1540 and the above-described artificial intelligence network module may confirm a value of the result output layer 1540 and estimate an arc energy level.

The dilated CNN layer 1510, which performs a main function in the artificial intelligence network 1500, may perform learning using learning data. According to an embodiment, a transfer learning method is used for enhancing the learning efficiency of the dilated CNN layer 1510.

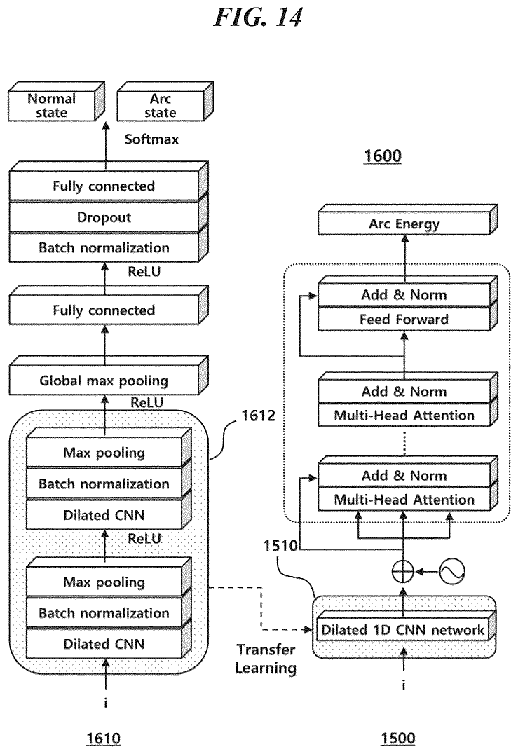

FIG. 14 is a configuration diagram of a learning device according to a fourth example of a first embodiment.

Referring to FIG. 14, a learning device 1100 may comprise two artificial intelligence networks 1610, 1500.

A first artificial intelligence network 1610 may comprise a first dilated CNN layer 1612, a global max pooling layer, a fully connected layer, and a classification layer including a batch normalization layer, a dropout layer, and a fully connected layer.

The first artificial intelligence network 1610 may perform learning using learning data classifying states of wires into a normal state and an arc state.

To the first artificial intelligence network 1610, measurement values grouped by a predetermined time section may be inputted. Here, current levels regarding the respective measurement values have already been checked. The first artificial intelligence network 1610 may perform learning for internal parameters in a way of comparing result values for the measurement values with previously checked state values (current level values).

Here, the measurement values inputted into the first artificial intelligence network 1610 may be measurement values for a current in an arc state.

A second artificial intelligence network 1500 may be the same as the artificial intelligence network described with reference to FIG. 13. The second artificial intelligence network 1500 may complete learning in the learning device 1600, and then, be inserted into an artificial intelligence network module of an assessment device.

The second artificial intelligence network 1500 may perform learning using learning data by which an arc energy level may be estimated.

The second artificial intelligence network 1500 may comprise a second dilated CNN layer 1510. The second dilated CNN layer 1510 may be a transfer learning layer from the first dilated CNN layer 1612. Before the second artificial intelligence network 1500 performs learning, the first dilated CNN layer 1612, which has previously performed learning in the first artificial intelligence network 1610, may be inserted in the second dilated CNN layer 1510. Then, the second artificial intelligence network 1500 may make the second dilated CNN layer 1510 perform learning through re-learning.

Using such transfer learning allows enhancing the accuracy of the second artificial intelligence network 1500, to be inserted in the artificial intelligence network module, and lightening the weight thereof.

Here, measurement values inputted into the second artificial intelligence network 1500 may be measurement values for a current in a pre-arc state and/or an arc state.

According to an embodiment, in order to enhance the accuracy and lighten the weight of an artificial intelligence network inserted in the artificial intelligence network module, various elements may be comprised.

A characteristic of an arc may be well revealed in a specific frequency band. When analyzing the frequency of an arc, a higher value can be verified in a specific frequency band. The artificial intelligence network according to an embodiment may confirm a specific frequency band well revealing an arc characteristic and input, into the artificial intelligence network, measurement values filtered by this frequency band or measured at a sampling rate corresponding to this frequency band. In this way, it is possible to lighten the weight of an artificial intelligence network while enhancing the accuracy thereof.

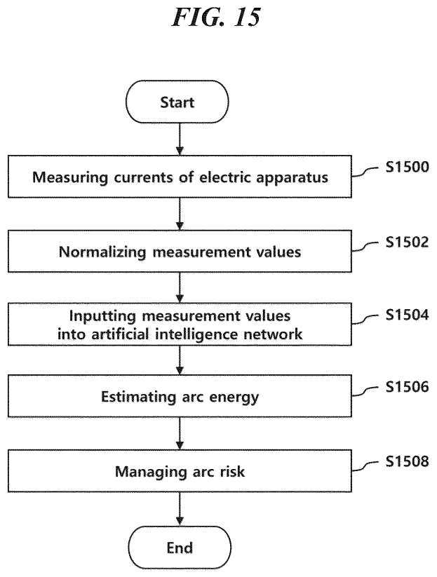

FIG. 15 is a flow diagram of an arc risk management method according to a first embodiment.

Referring to FIG. 15, an arc risk management system may measure currents flowing into an electric apparatus (S1500).

In addition, the arc risk management system may pre-process measurement values. Here, the arc risk management system may normalize the measurement values (S1502).

In S1502, the arc risk management system may normalize the measurement values without causing dispersion information to vanish from the measurement values.

For example, the arc risk management system may normalize the measurement values by a mean subtraction normalization (MSN) method.

The arc risk management system may input the pre-processed measurement values into an artificial intelligence network (S1504) and estimate the level of arc energy in the electric apparatus in this way (S1506).

The artificial intelligence network may comprise a first layer and a second layer, wherein the first layer may be a layer transferred from a first artificial intelligence network that has performed learning regarding the classification for first element values influencing the arc energy.

The first layer may comprise a convolutional neural network (CNN) favorable for extracting features and the second layer may comprise a long short-term memory (LSTM) accurate in the interpretation of time series data.

Further, the arc risk management system may indicate an arc risk of the electric apparatus in a quantitative way according to the level of arc energy (S1508).

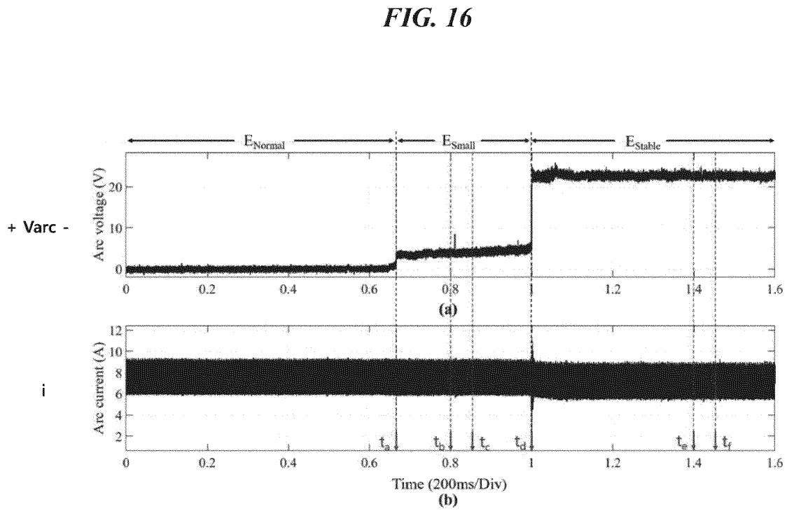

FIG. 16 is a diagram showing waveforms of a current and a voltage in an arc gap.

Referring to FIG. 16, it can be verified that the current and the voltage maintains normal waveforms during a time section Eₙₒᵣₘₐₗ which lasts until tₐ. It may be determined that the electric apparatus is in a normal state in this time section Eₙₒᵣₘₐₗ.

After tₐ, an arc gap is formed in the electric apparatus, however, high arc energy is not immediately formed in the arc gap. Where the arc energy becomes high is after t_{d}.

It may be determined that the electric apparatus is in an arc state in a time section E_{stable} after t_{d}. In a transient time section Eₛₘₐₗₗ between the normal state time section Eₙₒᵣₘₐₗ and the arc state time section E_{stable}, it may be determined that the electric apparatus is in a pre-arc state.

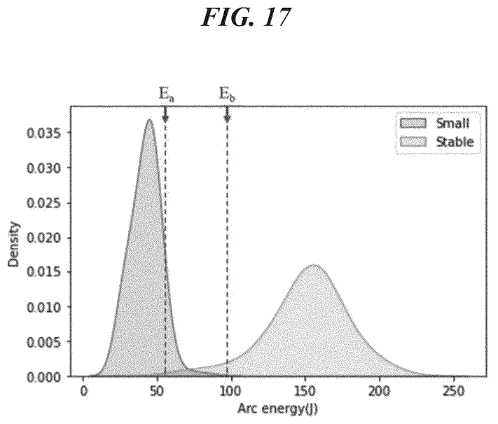

In order to compare the amount of arc energy in the pre-arc state and the amount of arc energy in the arc state, the amount of arc energy between t_{b} and t_{c} and the amount of arc energy between tₑ and t_{f} are calculated and its result is illustrated in FIG. 17.

FIG. 17 is a diagram showing arc energies in a pre-arc state and in an arc state.

Referring to FIG. 17, 95% of arc energy in the pre-arc state is lower than a first arc energy value Eₐ and 95% of arc energy in the arc state is higher than a second arc energy value E_{b}.

The second arc energy value E_{b} is higher than the first arc energy value Eₐ. According to FIG. 3, the second arc energy value E_{b} is 97.8 J and the first arc energy value Eₐ is 55.9 J. However, such values may differ depending on the length of a unit time, the size of the arc gap, or the like for calculating arc energy.

A device of an arc risk management system according to a second embodiment may determine whether the electric apparatus is in a normal state, a pre-arc state, or an arc state. The device may take a safety measure—for example, a measure of stopping the supply of electric power to the electric apparatus—when the electric apparatus is in the pre-arc state or the arc state.

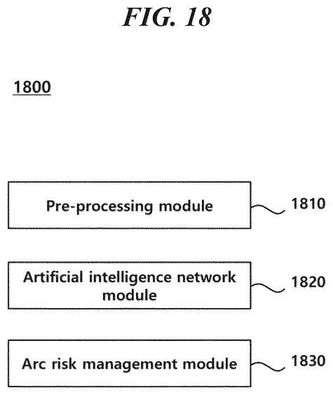

FIG. 18 is a configuration diagram of a device according to a second embodiment.

Referring to FIG. 18, a device 1800 may comprise a pre-processing module 1810, an artificial intelligence network module 1820, and an arc risk management module 1830.

The pre-processing module 1810 may obtain measurement values for currents of the electric apparatus.

In addition, the pre-processing module 1810 may pre-process the measurement values before the measurement values are inputted into an artificial intelligence network. For example, the pre-processing module 1810 may filter the measurement values by using a predetermined frequency band. Otherwise, the pre-processing module 1810 may pre-process the measurement values by controlling a sensor such that the measurement values are generated at a predetermined sampling rate.

The pre-processing module 1810 may group the measurement values of currents by a predetermined time section. The measurement values to be inputted into a below described artificial intelligence network may be understood as such measurement values grouped by a predetermined size of a time section.

The pre-processing module 1810 may normalize the measurement values. Methods of normalization may be various. However, the pre-processing module 1810 according to an embodiment may normalize the measurement values by a mean subtraction normalization (MSN) method.

The pre-processing module 1810 may normalize the measurement values in a method of calculating a mean value for each time section and subtracting a calculated mean value from each measurement value. As such, the mean subtraction normalization method makes a mean value of the measurement values 0, but distribution characteristics such as a standard deviation or the like would not be changed.

The artificial intelligence network module 1820 may comprise a pre-learned artificial intelligence network and classify the state of the electric apparatus into a normal state, an arc state, and a pre-arc state by using the artificial intelligence network.

The artificial intelligence network module 1820 may input the measurement values processed in the pre-processing module 1810 into the artificial intelligence network. The artificial intelligence network may comprise pre-learned parameters and output values to indicate states of the electric apparatus depending on the inputted measurement values.

There may be three types of values outputted from the artificial intelligence network to indicate the normal state, the arc state, and the pre-arc state.

The artificial intelligence network may comprise a convolutional neural network (CNN) layer. The CNN layer may be a transfer learning layer from another artificial intelligence network to distinguish two types of states, which are the normal state and the arc state. A learning method of an artificial intelligence network including transfer learning may be further described below.

In addition, the artificial intelligence network may comprise an exponential linear unit (ELU), not a rectified linear unit (ReLU).

Output values from the artificial intelligence network module 1810 may be transferred to the arc risk management module 1830. The arc risk management module 1830 may determine whether any arc occurs in the electric apparatus by using the output values and take a final safety measure.

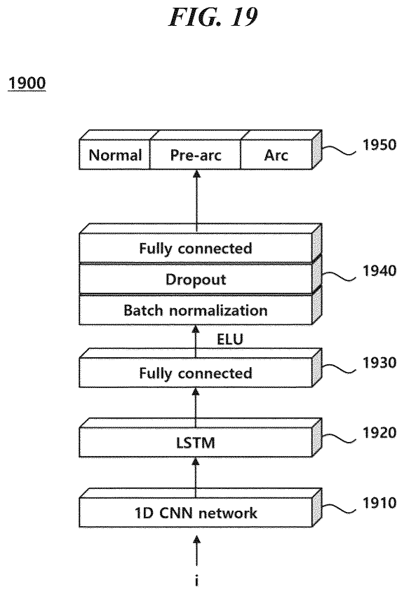

FIG. 19 is a configuration diagram of an artificial intelligence network according to a second embodiment.

Referring to FIG. 19, an artificial intelligence network 1900 may comprise a convolutional neural network (CNN) layer 1910, a long short-term memory (LSTM) layer 1920, classification layers 1930, 1940, and a result output layer 1950.

The CNN layer 1910 may be a one dimension (1D) CNN and current measurement values, grouped by a predetermined time section, may be inputted into the CNN layer 1910.

The LSTM layer 1920, which is one type of recurrent neural network (RNN) method, is a layer developed for preventing the vanishing gradient problem, which is a problem of the conventional RNNs. An output from the CNN layer 1910 may be transferred to the LSTM layer 1920 and an output from the LSTM layer 1920 may be transferred to the classification layers 1930, 1940.

The classification layers 1930, 1940 may comprise a fully connected layer 1930, including an exponential linear unit (ELU), and another layer 1940 including a batch normalization layer, a dropout layer, and a fully connected layer.

A result outputted from the classification layers 1930, 1940 may be expressed by the result output layer 1950 and the above-described artificial intelligence network module may confirm a value of the result output layer 1950 and determine the state of the electric apparatus—the normal state, the arc state, and the pre-arc state.

The CNN layer 1910, which performs a main function in the artificial intelligence network 1900, may perform learning using learning data. According to an embodiment, a transfer learning method is used for enhancing the learning efficiency of the CNN layer 1910.

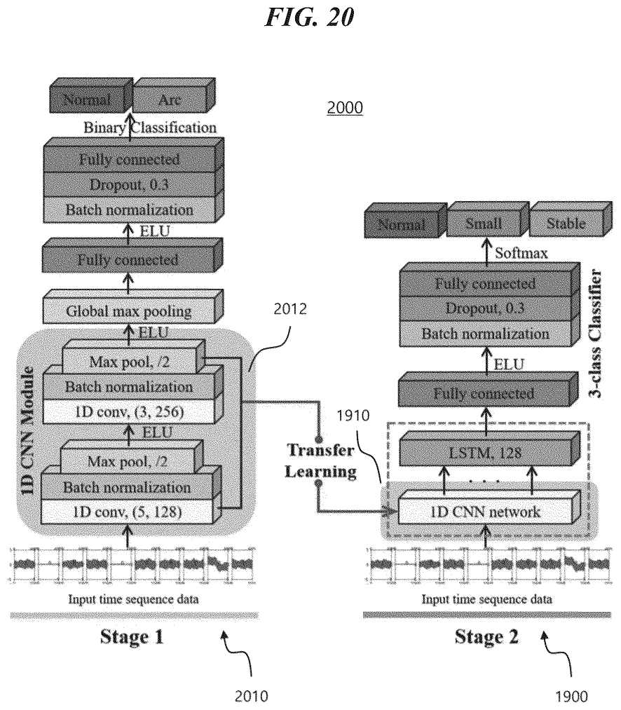

FIG. 20 is a configuration diagram of a learning device according to a second embodiment.

Referring to FIG. 20, a learning device 2000 may comprise two artificial intelligence networks 2010, 1900.

A first artificial intelligence network 2010 may comprise a first CNN layer 2012, a global max pooling layer, a fully connected layer, and a classification layer including a batch normalization layer, a dropout layer, and a fully connected layer.

The first artificial intelligence network 2010 may perform learning using learning data to be classified into only two states, which are the normal state and the arc state.

To the first artificial intelligence network 2010, measurement values grouped by a predetermined time section may be inputted. Here, a check, as to whether the respective measurement values indicate the normal state or the arc state, has already been made. The first artificial intelligence network 2010 may perform learning for internal parameters in a way of comparing result values for the measurement values with previously checked state values (respectively indicating either the normal state or the arc state).

A second artificial intelligence network 1900 may be the same as the artificial intelligence network described with reference to FIG. 19. The second artificial intelligence network 1900 may complete learning in the learning device 2000, and then, be inserted into an artificial intelligence network module of an arc detection device.

The second artificial intelligence network 1900 may perform learning using learning data to be classified into three states, that is, the normal state, the arc state, and the pre-arc state.

The second artificial intelligence network 1900 may comprise a second CNN layer 1910. The second CNN layer 1910 may be a transfer learning layer from the first CNN layer 2012. Before the second artificial intelligence network 1900 performs learning, the first CNN layer 2012, which has previously performed learning in the first artificial intelligence network 2010, may be inserted in the second CNN layer 1910. Then, the second artificial intelligence network 1900 may make the second CNN layer 1910 to perform learning through re-learning.

Using such transfer learning allows enhancing the accuracy of the second artificial intelligence network 1900, inserted in the artificial intelligence network module, and lightening the weight thereof.

According to the second embodiment, in order to enhance the accuracy and lighten the weight of an artificial intelligence network inserted in the artificial intelligence network module, various elements may be comprised.

A characteristic of an arc may be well revealed in a specific frequency band. When analyzing the frequency of an arc, a higher value can be verified in a specific frequency band. The artificial intelligence network according to an embodiment may confirm a specific frequency band well revealing an arc characteristic and input, into the artificial intelligence network, measurement values filtered by this frequency band or measured at a sampling rate corresponding to this frequency band. In this way, it is possible to lighten the weight of an artificial intelligence network while enhancing the accuracy thereof.

In order to confirm such a specific frequency band, the Grad-CAM may be used.

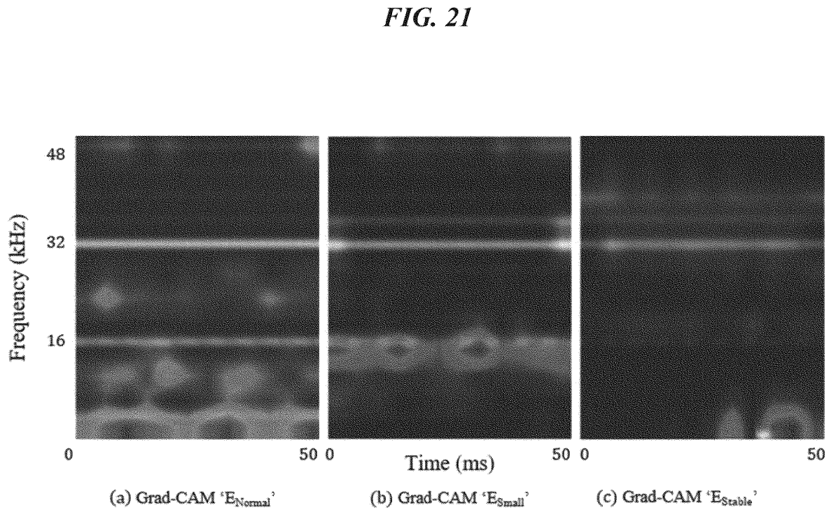

FIG. 21 is an illustrative diagram of a result of a heat map produced by the Grad-CAM.

An architect of an artificial intelligence network may input learning data, which has previously classified into the normal state, the pre-arc state, and the arc state, into the Grad-CAM and confirm a result of a heat map having a time axis and a frequency axis.

As shown in FIG. 21, characteristics of the normal state, the pre-arc state, and the arc state may be shown at or below 20 KHz. However, this is only an example. Such frequency characteristics may differ depending on electric apparatuses.

Based on such a result of the heat map, an architect of an artificial intelligence network may set a sampling rate for a current to be at or below 20 KHz or a frequency band to be at or below 20 KHz by using a low pass filter. In this way, the accuracy of an artificial intelligence network may be enhanced and the weight of an artificial intelligence network may be lightened.

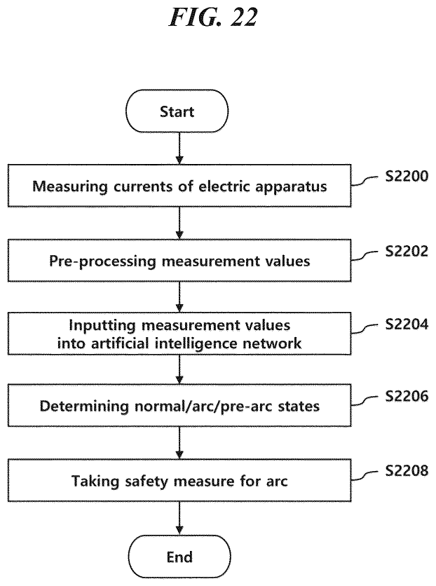

FIG. 22 is a flow diagram of a method for detecting pre-arcs according to a second embodiment.

Referring to FIG. 22, an arc risk management system may measure currents of an electric apparatus (S2200).

The arc risk management system may measure currents at a predetermined sampling rate. An architect of an artificial intelligence network may input learning data, which has previously classified into the normal state, the pre-arc state, and the arc state, into the Grad-CAM and determine the sampling rate by using an outputted result of a heat map having a time axis and a frequency axis.

The arc risk management system may pre-process measurement values (S2202).

The arc risk management system may filter the measurement values by using a predetermined frequency band.

The arc risk management system may normalize the measurement values. The arc risk management system may normalize the measurement values by using a mean subtraction normalization method.

The arc risk management system may input the pre-processed measurement values into the artificial intelligence network (S2204).

The artificial intelligence network may comprise a CNN layer. The CNN layer may be a transfer learning layer from another artificial intelligence network to distinguish two types of states, the normal state and the arc state.

In addition, the artificial intelligence network may comprise an exponential linear unit (ELU).

The arc risk management module may determine whether the electric apparatus is in the normal state, the arc state, or the pre-arc state by using the artificial intelligence network (S2206).

The arc risk management system may take a safety measure when the electric apparatus is in the pre-arc state or the arc state (S2208).

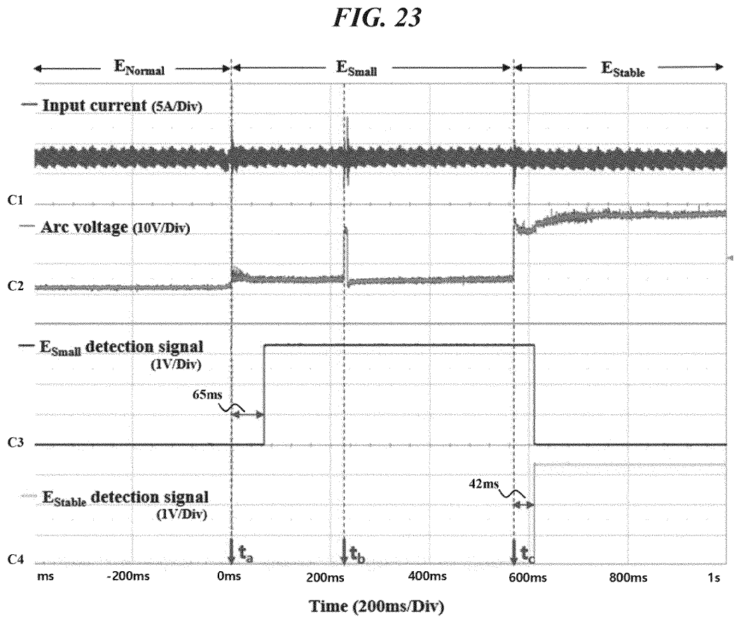

FIG. 23 is a diagram showing an experiment result of an arc risk management system according to a second embodiment.

Referring to FIG. 23, it can be verified that the arc risk management system detected the pre-arc state of the electric apparatus 65 ms after a time point tₐ where the electric apparatus has entered the pre-arc state.

In addition, it can be verified that the arc risk management system detected the arc state of the electric apparatus 42 ms after a time point t_{c} where the electric apparatus has entered the arc state.

Further, it can be verified that the arc risk management system made a stable determination—the determination that the electric apparatus is in the pre-arc state—even at a time point t_{b} where big arc energy occurred as noise when the electric apparatus was in the pre-arc state.

As described above, according to the present disclosure, the level of arc energy in an electric apparatus may be more accurately measured. In addition, according to the present disclosure, risks due to arcs in an electric apparatus may be managed.

Since terms, such as “including,” “comprising,” and “having” mean that corresponding elements may exist unless they are specifically described to the contrary, it shall be construed that other elements can be additionally included, rather than that such elements are excluded. All technical, scientific, or other terms are used consistently with the meanings as understood by a person skilled in the art unless defined to the contrary. Common terms as found in dictionaries should be interpreted in the context of the related technical writings, rather than overly ideally or impractically, unless the present disclosure expressly defines them so.

Although a preferred embodiment of the present disclosure has been described for illustrative purposes, those skilled in the art will appreciate that various modifications, additions, and substitutions are possible without departing from the scope and spirit of the embodiment as disclosed in the accompanying claims. Therefore, the embodiments disclosed in the present disclosure are intended to illustrate the scope of the technical idea of the present disclosure, and the scope of the present disclosure is not limited by the embodiment. The scope of the present disclosure shall be construed on the basis of the accompanying claims in such a manner that all of the technical ideas included within the scope equivalent to the claims belong to the present disclosure.

What is claimed is:

1. An arc risk management method comprising:
pre-processing measurement values of currents flowing into an electric apparatus;
estimating a level of arc energy in the electric apparatus by inputting the measurement values into one artificial intelligence network comprising a first layer including a dilated convolutional neural network and a second layer including a recurrent neural network; and
indicating an arc risk of the electric apparatus in a quantitative way according to the level of arc energy.

2. The arc risk management method of claim 1, wherein, in indicating an arc risk in a quantitative way, the arc risk is indicated in a form of a dial gauge in real time.

3. The arc risk management method of claim 1, wherein the first layer is a layer transferred from another artificial intelligence network, which has conducted learning for classification of first factor values to influence the arc energy.

4. The arc risk management method of claim 1, wherein the recurrent neural network comprises a long short-term memory (LSTM), which is advantageous for time series data analysis.

5. The arc risk management method of claim 1, wherein the recurrent neural network comprises a transformer layer.

6. The arc risk management method of claim 3, wherein the other artificial intelligence network distinguishes a normal state and an arc state of the electrical apparatus through the classification.

7. Arc risk management system comprising:
a pre-processing module to pre-process measurement values of currents flowing into an electric apparatus;
an artificial intelligence network module, comprising a first layer including a dilated convolutional neural network and a second layer including a recurrent neural network, to receive the measurement values as an input and to output a level of arc energy of the electric apparatus; and
an arc risk management module to indicate an arc risk of the electric apparatus in a quantitative way according to the level of arc energy.

8. The arc risk management system of claim 7, wherein the pre-processing module normalizes the measurement values without causing dispersion information to vanish from the measurement values.

9. The arc risk management system of claim 8, wherein the pre-processing module normalizes the measurement values by a mean subtraction normalization (MSN) method.

10. The arc risk management system of claim 7, wherein the first layer is a layer transferred from another artificial intelligence network, which has conducted learning for classification of first factor values to influence the arc energy.

11. The arc risk management system of claim 7, wherein the recurrent neural network comprises a long short-term memory (LSTM), which is advantageous for time series data analysis.

12. The arc risk management system of claim 7, wherein an artificial intelligence network has a structure of a residual neural network (ResNet).

13. The arc risk management system of claim 10, wherein the other artificial intelligence network classifies the measurement values into two or more current levels.

14. The arc risk management system of claim 7, further comprising a display module to indicate quantitative indexes of the arc risk in a form of a gauge.

15. The arc risk management system of claim 10, wherein the first factor values are current levels and the other artificial intelligence network is an artificial intelligence network which has learned to classify levels of currents flowing into the electrical apparatus in a state where an arc has occurred.
